(19) United States
(12) Patent Application Publication
(10) Pub. No.: US 2017/0123191 A1
(43) Pub. Date: May 4, 2017

(54) WIDE-ANGLE LENS SYSTEM

(71) Applicant: HON HAI PRECISION INDUSTRY CO., LTD., New Taipei (TW)

(72) Inventors: KUANG-JU WANG, New Taipei (TW); TE-LUN HSU, Tu-Cheng (TW); CHENG-HUNG HSING, Tu-Cheng (TW)

(21) Appl. No.: 15/080,708

(22) Filed: Mar. 25, 2016

(30) Foreign Application Priority Data
Oct. 30, 2015 (TW) 104135943

(51) Int. Cl. G02B 13/04; G02B 13/00; G02B 27/00; G02B 9/10

(52) U.S. Cl. CPC G02B 13/04; G02B 9/10; G02B 13/003; G02B 27/0025; G02B 5/20

(57) ABSTRACT

A wide angle lens system, in order from an object side to an image side, the wide angle lens system includes a first lens with negative refraction power, a second lens with positive refraction power, and an image plane. The wide angle lens system is satisfied with the following formulas: (1) 5<TTL/f<7; (2) −1.9<f₁/f<−1.0; (3) 1.0<f₂/f<2.0, where TTL is a distance between an object side surface of the first lens and the image plane, f is a focal length of the wide angle lens system, f₁ is a focal length of the first lens, f₂ is a focal length of the second lens.

### FIELD

The subject matter herein generally relates to a wide angle lens system.

### BACKGROUND

In the field of photography, a wide angle lens can capture an image of an object with a wide angle (the field angle>100°) of view in high resolution. Many mobile phones and image systems, such as a surveillance cameras, are now equipped with the wide angle lens. Conventionally, optical aberrations are larger when the field angle is wider, especially field curvatures, which lowers the resolution of the image.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is a diagrammatic view of a wide angle lens system with two lenses.

FIG. 2 is a graph respectively showing field curves of a first embodiment of the wide angle lens system of FIG. 1.

FIG. 3 is a graph showing distortion of the first embodiment of the wide angle lens system of FIG. 1.

FIG. 4 is a graph showing longitudinal spherical aberration of the first embodiment of the wide angle lens system of FIG. 1.

FIG. 5 is a graph showing field curves of a second embodiment of the wide angle lens system of FIG. 1.

FIG. 6 is a graph showing distortion of the second embodiment of the wide angle lens system of FIG. 1.

FIG. 7 is a graph showing longitudinal spherical aberration of the second embodiment of the wide angle lens system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to;” it specifically indicates open-ended inclusion or membership in the so-described combination, group, series and the like.

The present disclosure relates to a wide angle lens system.

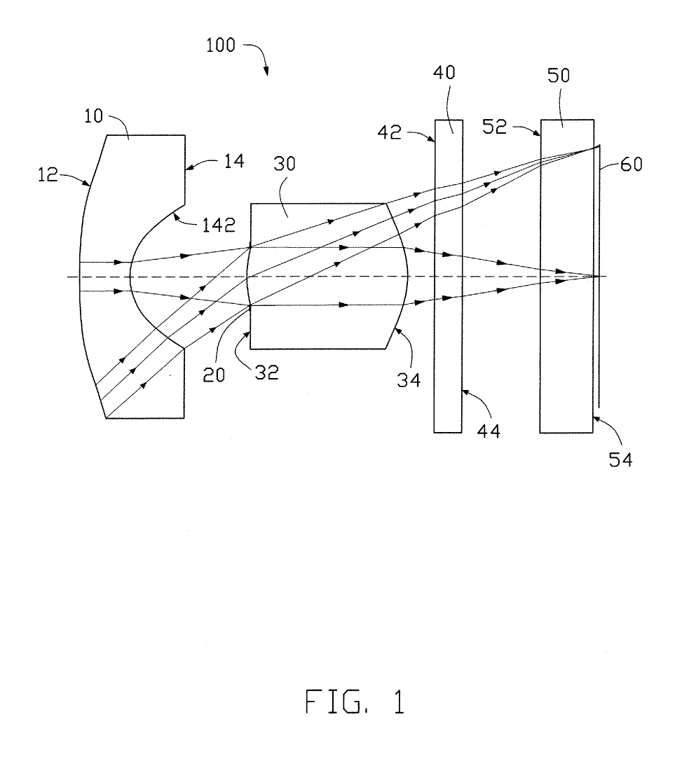

FIG. 1 illustrates a wide angle lens system 100 includes a first lens 10 with negative refraction power, an aperture 20, a second lens 30 with positive refraction power, a filter 40, a glass cover 50, and an image plane 60 in the order from an object side to an image side. Each one of the first lens 10, the second lens 30, the filter 40, and the glass cover 50 includes an object side surface 12, 32, 42, and 52, and an image side surface 14, 34, 44, and 54.

The first lens 10 is an aspheric lens. The object side surface 12 and the image side surface 14 of the first lens 10 are an aspheric surface, the image side surface 14 of the first lens 10 includes a concave surface 142, and the concave surface 142 is configured to rotate symmetrically about a central optical axis of the first lens 10.

The aperture 20 is positioned on the object side surface 32 of the second lens 30, the aperture 20 is configured to rotate symmetrically about a central optical axis of the second lens 30. The aperture 20 is configured to control optical aberrations of light.

The second lens 30 is an aspheric lens. The object side surface 32 and the image side surface 34 of the second lens 30 are an aspheric surface. The image side surface 34 of the second lens 30 is a convex surface. A central optical axis of the second lens 30 is aligned with the central optical axis of the first lens 10.

The filter 40 is configured to transmit an infrared light with a wavelength range of 800-850 nm, and to filter out others like an ultraviolet light or a visible light.

The glass cover 50 is configured to protect the image plane 60 and keep the image plane 60 clean.

A light from an object couples to the wide angle lens system 100 and is focused by the first lens 10 and the second lens 30, the filter 40 and the glass cover 50 transmit the light to the image plane 60. The light is positioned on the image plane 60 and an image of the object is constituted on the image plane 60 by a sensor (not shown).

The wide angle lens system 100 satisfies the formulas:

5<TTL/f<7; (1)

−1.9</f<−1.0; (2)

1.0<f₂/f<2.0; (3)

where TTL is a distance between the object side surface 12 of the first lens 10 and the image plane 60, f is a focal length of the wide angle lens system 100, f₁ is a focal length of the first lens 10, f₂ is a focal length of the second lens 20. Formula (1) is used for decreasing the total thickness of the wide angle lens system 100. Formula (2) is used for capturing the image of the object with high quality in a wide angle. Formula (3) is used for correcting the optical aberrations of the image.

In a first embodiment, the wide angle lens system 100 satisfies the parameters of Tables 1-2. The symbols listed below are used in Tables 1 and Table 2, where a diameter, L, of the aperture 20 is satisfied L=0.113 mm, a field angle, 2ω, of the wide angle lens system 100 is satisfied 2ω=123°. Listed below are the symbols used in Table 1:

R: a radius of curvature,

D: a distance between surfaces on the optical axis,

Nd: a refractive index of lens corresponding to a light of wavelength 850 nm,

Vd: an Abbe number corresponding to a light of wavelength 850 nm,

TABLE 1

| surface | | R(mm) | D(mm) | Nd | Vd |
|---|---|---|---|---|---|
| first lens | object side surface | 7.913 | 0.38 | 1.585 | 29.909 |
| | image side surface | 0.482 | 0.903 | — | — |
| aperture | — | Infinity | −0.02 | — | — |
| second lens | object side surface | 0.981 | 1.205 | 1.585 | 29.909 |
| | image side surface | −0.720 | 0.2 | — | — |
| filter | object side surface | Infinity | 0.21 | 1.517 | 64.167 |
| | image side surface | Infinity | 0.579 | — | — |
| glass cover | object side surface | Infinity | 0.4 | 1.517 | 64.167 |
| | image side surface | Infinity | 0.045 | — | — |
| image surface | — | Infinity | — | — | — |

TABLE 2

| | first lens | | second lens | |
|---|---|---|---|---|
| aspherical | object side | image side | object side | image side |
| coefficient | surface | surface | surface | surface |
| k | 19.58215 | −0.7989252 | −3.18624 | −5.553802 |
| A4 | 0.38600528 | 0.33912695 | 0.2488857 | −0.95245255 |
| A6 | −0.45172398 | 8.1102878 | 2.7837464 | 3.7521578 |
| A8 | 0.21625576 | −28.364711 | −154.41319 | −5.8404985 |
| A10 | −0.04184653 | 21.127064 | 1751.9136 | 5.4532602 |

The even aspherical surfaces are shaped according to the formula:

$$Z = \frac{{ch}^{2}}{1 + \sqrt{1 - ( k + 1 ) {c}^{2} {h}^{2}}} + \sum {A}_{i} {h}^{i} \qquad ( 1 )$$

where Z is a displacement of the z-component from the aspherical surface to a vertex of the aspherical surface, h is a height from the optical axis of the lenses to the aspherical surface, c is a radius of curvature, k is a conic constant, and Ai are i-th order correction coefficients of the aspherical surfaces.

In the first embodiment of the wide angle lens system 100, the wide angle lens system 100 satisfies TTL=3.9, f=0.6409, f₁=−0.9159, f₂=0.9795, TTL/f=6.085, f₁/f=−1.429, f₂/f=1.528.

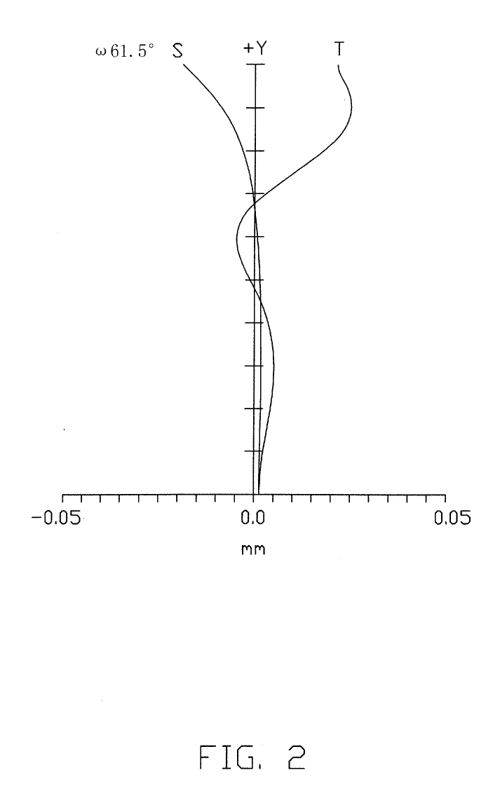

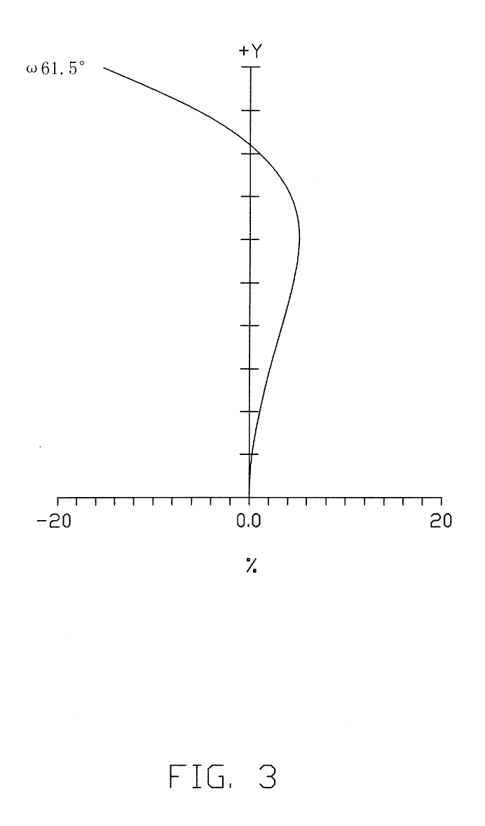

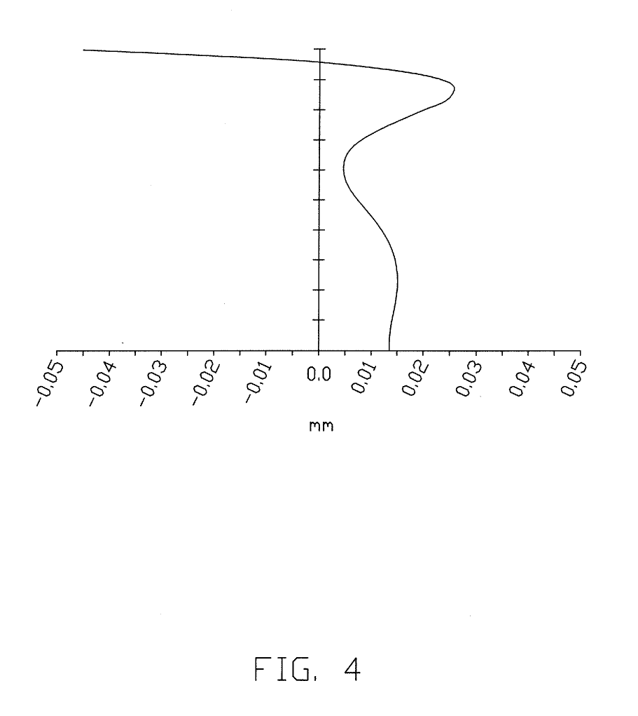

In the first embodiment, the spherical aberration graph, the field curvature graph, and the distortion graph of the wide angle lens system 100 are respectively shown in FIGS. 2-4. The sagittal field curvature and the tangential field curvature shown in FIG. 2 are kept within a range of −0.05 mm to 0.05 mm. The distortion in FIG. 3 falls within a range of −20% to 20%. The spherical aberration of visible light (with a wavelength 850 nm) shown in FIG. 4 is within a range of −0.05 mm to 0.05 mm. In the embodiment, the spherical aberration, field curvature, and distortion are well controlled in the wide angle lens system 100 with high quality in a wide angle 2ω>123°.

In a second embodiment, the wide angle lens system 100 satisfies the parameters of Tables 3-4. The symbols listed below are used in Tables 3 and Table 4, where a diameter of the aperture 20 is satisfied L=0.118 mm, a field angle of the wide angle lens system 100 is satisfied 2ω=121.4°. Listed below are the symbols used in Table 3:

R: a radius of curvature,

D: a distance between surfaces on the optical axis,

Nd: a refractive index of lens corresponding to a light of wavelength 850 nm,

Vd: an Abbe number corresponding to a light of wavelength 850 nm,

TABLE 3

| surface | | R(mm) | D(mm) | Nd | Vd |
|---|---|---|---|---|---|
| first lens | object side surface | 7.979 | 0.38 | 1.756 | 45.6 |
| | image side surface | 0.573 | 0.886 | — | — |
| aperture | — | Infinity | −0.02 | — | — |
| second lens | object side surface | 0.876 | 1.160 | 1.543 | 62.9 |
| | image side surface | −0.715 | 0.2 | — | — |
| filter | object side surface | Infinity | 0.21 | 1.517 | 64.167 |
| | image side surface | Infinity | 0.639 | — | — |
| glass cover | object side surface | Infinity | 0.4 | 1.517 | 64.167 |
| | image side surface | Infinity | 0.045 | — | — |
| image surface | — | Infinity | — | — | — |

TABLE 4

| | first lens | | second lens | |
|---|---|---|---|---|
| aspherical | object side | image side | object side | image side |
| coefficient | surface | surface | surface | surface |
| k | 39.7824 | −0.7857051 | −2.689253 | −5.049221 |
| A4 | 0.40250313 | 0.47981193 | 0.27430932 | −0.90899426 |
| A6 | −0.46630568 | 7.1748517 | −0.15813058 | 4.0270703 |
| A8 | 0.22114722 | −29.581975 | −46.809173 | −6.5218931 |
| A10 | −0.04301957 | 31.475821 | 641.70653 | 8.080909 |

In the second embodiment of the wide angle lens system 100, the wide angle lens system 100 also satisfies TTL=3.9, f=0.66, f₁=−0.85, f₂=0.986, TTL/f=5.909, f₁/f=−1.288, f₂/f=1.494.

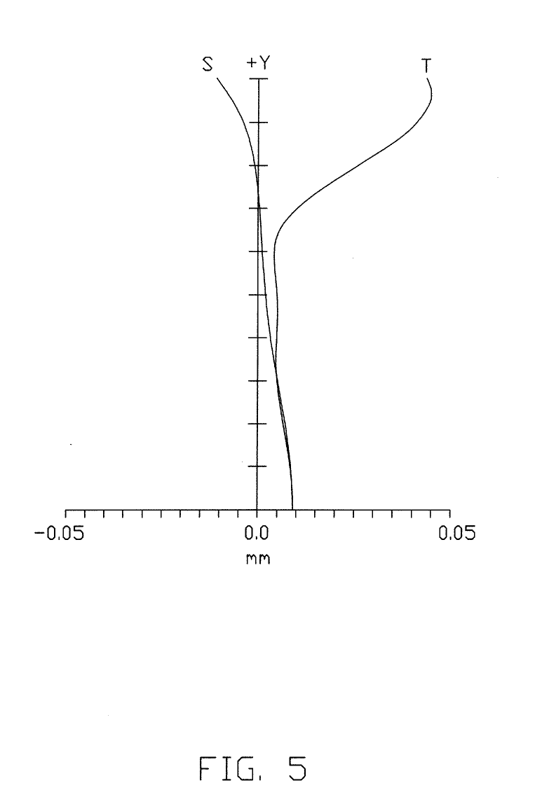

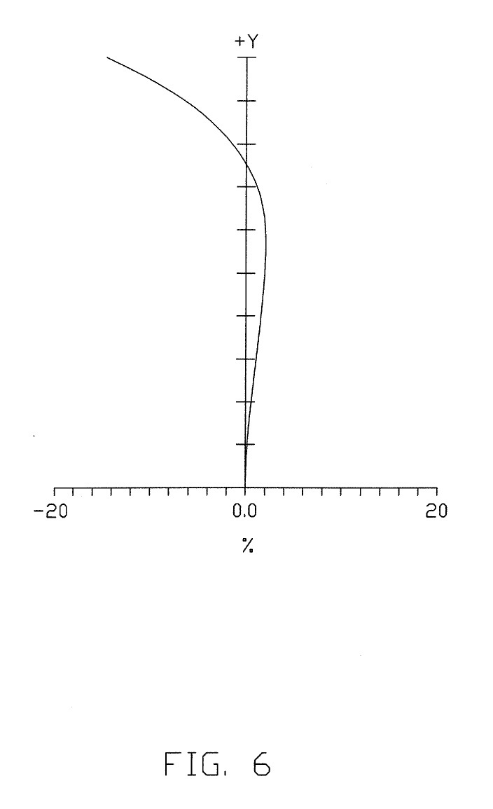

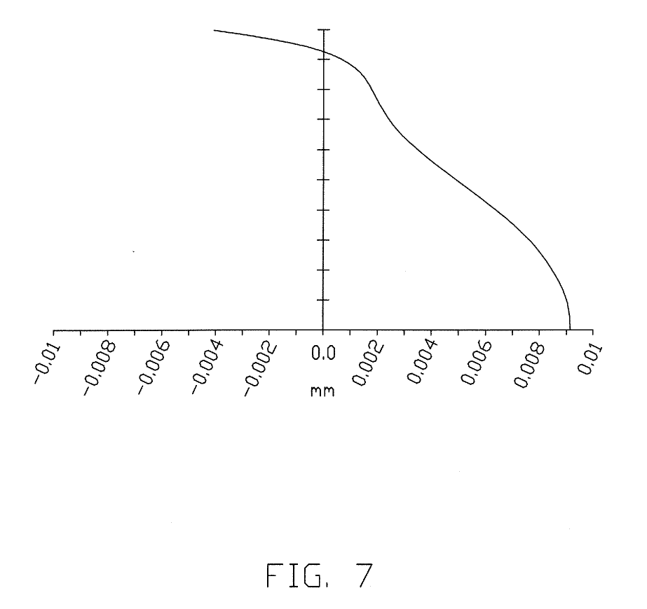

In the second embodiment, the spherical aberration graph, the field curvature graph, and the distortion graph of the wide angle lens system 100 are respectively shown in FIGS. 5-7. The sagittal field curvature and the tangential field curvature shown in FIG. 5 are kept within a range of −0.05 mm to 0.05 mm. The distortion in FIG. 6 falls within a range of −20% to 20%. The spherical aberration of visible light (with a wavelength 850 nm) shown in FIG. 7 is within a range of −0.01 mm to 0.01 mm. In the embodiment, the spherical aberration, field curvature, and distortion are well controlled in the wide angle lens system 100 with high quality in a wide angle 2ω>121.5°.

The embodiments shown and described above are only examples. Many details are often found in the art such as the other features of a wide angle lens system. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A wide angle lens system, in order from an object side to an image side, the wide angle lens system comprising:
a first lens with negative refraction power including a first surface on the object side;
a second lens with positive refraction power; and
an image plane;
wherein the wide angle lens system is satisfied following formulas:
5<TTL/f<7;
−1.9</f<−1.0;
1.0<f₂/f<2.0;
where TTL is a distance between the first surface and the image plane, f is a focal length of the wide angle lens system, f₁ is a focal length of the first lens, f₂ is a focal length of the second lens.

2. The wide angle lens system in accordance with claim 1, wherein the first lens includes a concave surface on the image side, the concave surface is configured to rotate symmetrically about a central optical axis of the first lens.

3. The wide angle lens system in accordance with claim 1, wherein the second lens has a convex surface on the image side.

4. The wide angle lens system in accordance with claim 1, wherein both of the first lens and the second lens are an aspheric lens.

5. The wide angle lens system in accordance with claim 1, wherein the wide angle lens system includes an aperture positioned between the first lens and the second lens, the aperture is configured to rotate symmetrically about a central optical axis of the second lens.

6. The wide angle lens system in accordance with claim 1, wherein the wide angle lens system includes a filter, and a glass cover, the glass cover is positioned behind the image plane, the filter is positioned between the second lens and the cover lens.

7. The wide angle lens system in accordance with claim 1, wherein the wide angle lens system includes a filter, and a glass cover, the filter is positioned behind the image plane, the glass cover is positioned between the second lens and the filter.

8. The wide angle lens system in accordance with claim 1, wherein the first lens and the second lens are a glass.
